(19) United States
(12) Patent Application Publication
(10) Pub. No.: US 2009/0252057 A1
(43) Pub. Date: Oct. 8, 2009

(54) WIRELESS SERVICE PROCESSOR CONNECTIONS

(76) Inventors: DIANE G. FLEMMING, Pflugerville, TX (US); Ghadir R. Gholami, Austin, TX (US); Octavian F. Herescu, Austin, TX (US); William A. Maron, Austin, TX (US); Mysore S. Srinivas, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 12/061,242

(22) Filed: Apr. 2, 2008

(51) Int. Cl. H04Q 7/24

(52) U.S. Cl. 370/254

(57) ABSTRACT

A method and system for replacing physical connections within a large enterprise system with wireless connections. A first wireless transceiver is associated with a node, wherein the node comprises one or more system service processors. A second wireless transceiver is associated with a main system service processor. System service processors associated with the node, referred to as node service processors, are assigned a unique identification (ID), e.g., a name and/or number, to identify the node service processors during wireless connection. An Ethernet cable is utilized to connect the node service processors to the main system service processor. The unique identification is transferred from the main system service processor to the node service processor, and then the Ethernet cable is disconnected. When the Ethernet cable is disconnected, the node service processor(s) communicate with the main system service processor via a wireless network utilizing the transceivers and unique IDs.

### BACKGROUND

1. Technical Field

The present invention generally relates to computer systems and in particular to service processors in a computer enterprise system.

2. Description of the Related Art

As information technology has matured, computing systems have evolved into what are now known as “large enterprise computing systems.” An enterprise computing system is typically a large number of computing and storage devices, all of which are employed by users from a single concern, or “enterprise.”

Currently, large enterprise computing systems consist of multiple hardware nodes connected together. Each hardware node comprises at least two service processors which connect to the service processor within the system. The service processors are connected via Ethernet cables, thereby creating a massive array of cables when multiple service processors are utilized. Networks comprising large amounts of cables, such as Ethernet cables, are disorderly, and develop a large number of cable-related and user-related errors from cables connected incorrectly; thereby yielding highly dysfunctional systems.

### SUMMARY OF ILLUSTRATIVE EMBODIMENTS

Disclosed are a method and system for replacing physical connections within a large enterprise system with wireless connections. A first wireless transceiver is associated with a node, wherein the node comprises one or more system service processors. A second wireless transceiver is associated with a main system service processor. System service processors associated with the node, called node service processors, are assigned a unique identification (name and/or number) to identify the node service processors during wireless connection. An Ethernet cable is utilized to connect the node service processors to the main system service processor. The unique identification is transferred from the main system service processor to the node service processor, and then the Ethernet cable is disconnected. When the Ethernet cable is disconnected, the node service processor(s) communicate with the main system service processor via a wireless network utilizing the respective wireless transceivers and unique IDs. The above as well as additional features of the present invention will become apparent in the following detailed written description.

### BRIEF DESCRIPTION OF THE DRAWINGS

The invention itself will best be understood by reference to the following detailed description of an illustrative embodiment when read in conjunction with the accompanying drawings, wherein:

FIG. 1 illustrates a node within an enterprise system that is associated with a main system service processor according to one embodiment of the invention;

FIG. 2 illustrates an enterprise system in accordance with one embodiment of the invention;

FIG. 3 illustrates a node service processor's physical connection to a main system service processor according to one embodiment of the invention;

FIG. 4 illustrates a node service processor's wireless connection to a main system service processor in accordance with one embodiment of the invention; and

FIG. 5 is a logic flow chart illustrating the method for introducing a node service processor into a wireless enterprise system according to one embodiment of the invention.

### DETAILED DESCRIPTION OF AN ILLUSTRATIVE EMBODIMENT

The illustrated embodiments provide a method and system for replacing physical connections within a large enterprise system with wireless connections. A first wireless transceiver is associated with a node, wherein the node comprises one or more system service processors. A second wireless transceiver is associated with a main system service processor. System service processors associated with the node, referred to as node service processors, are assigned a unique identification (ID), e.g., a name and/or number, to identify the node service processors during wireless connection. An Ethernet cable is utilized to connect the node service processors to the main system service processor. The unique identification is transferred from the main system service processor to the node service processor, and then the Ethernet cable is disconnected. When the Ethernet cable is disconnected, the node service processor(s) communicate with the main system service processor via a wireless network utilizing the respective wireless transceivers and unique IDs.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

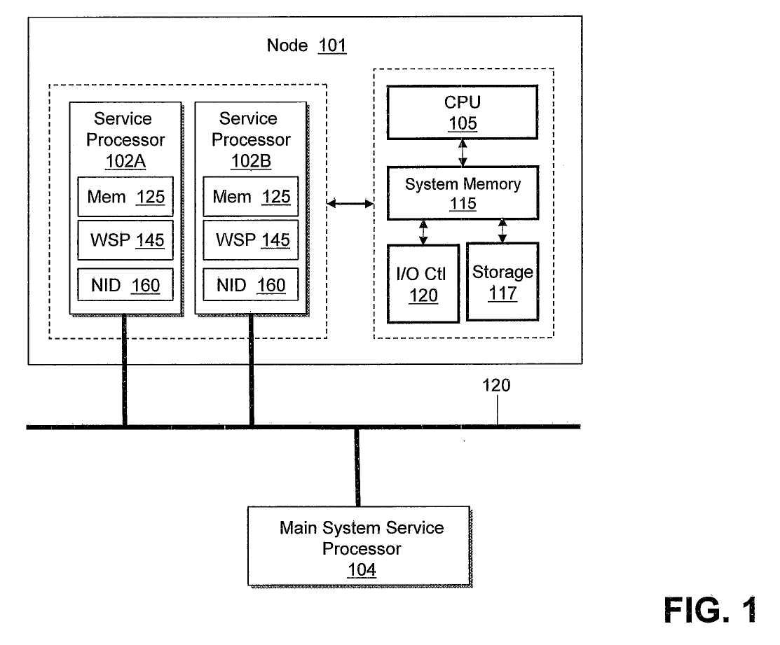

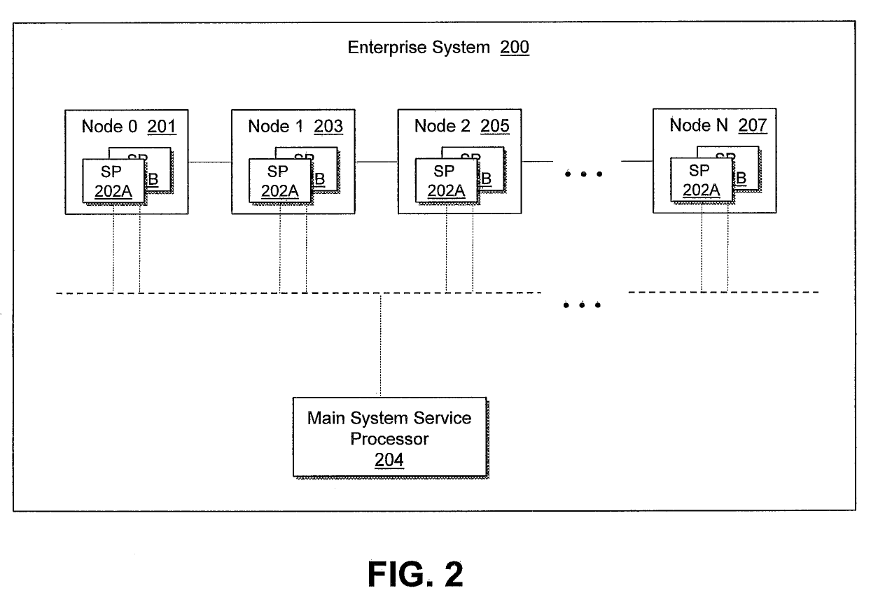

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIGS. 1 and 2xx for FIG. 2). The specific numerals assigned to the elements are provided solely to aid in the description and not meant to imply any limitations (structural or functional) on the invention.

It is understood that the use of specific component, device and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that terms is utilized. Specifically, as utilized herein, the term node may be any device connected within a computer network. The term node in the current specification identifies one or more node service processors within a device connected to a computer network.

With reference now to the figures, FIG. 1 depicts a block diagram representation of an enterprise system node. Node 101 comprises at least one processor or central processing unit (CPU) 105 connected to system memory 115 via system interconnect/bus 110. Also connected to system bus 105 is I/O controller 120, which provides connectivity and control for input devices. Additionally, node 101 comprises storage 117, within which data/instructions/code may be stored.

Node 101 is also illustrated with service processor 102A and 102B, wherein service processor 102B is a redundant service processor. Within service processor 102A and 102B are memory 115, network interface device (NID) 160, with which node 101 connects to main system service processor 104, which may be within a server (as depicted in FIG. 2). NID 160 of service processor 102A and 102B may be connected to main system service processor 104 via Ethernet cable 120. NID 160 may utilize the Transmission Control Protocol/Internet Protocol (TCP/IP) suite of protocols to enable service processor 102A and 102B to communicate with main system service processor 104.

Notably, in addition to the above described hardware components of node 101, various features of the invention are completed via software (or firmware) code or logic stored within memory 115 of service processor 102A and 102B. Thus, illustrated within service processor 102A and 102B is software/firmware component, wireless service processor (WSP) utility 145. In actual implementation, WSP utility 145 may be combined with an additional software component or application within node 101. WSP utility 145 and the additional software may be utilized as a single application collectively providing the various functions of each individual software component when the corresponding code is executed by CPU 105. For simplicity, WSP utility 145 is illustrated and described as a stand alone or separate software/firmware component, which provides specific functions, as described below.

CPU 105 executes WSP utility 145 as well the operating system within Node 101, which may support the user interface features of WSP utility 145. In the illustrative embodiment, WSP utility 145 generates/provides several graphical user interfaces (GUI) to enable user interaction with, or manipulation of, the functional features of the utility (145). Among the software code/instructions provided by WSP utility 145, and which are specific to the invention, are: (a) code for associating a wireless connection with one or more node service processors; (b) code for assigning an unique identification name to the one or more node service processors; and (c) code for detecting a wireless connection of one or more node service processors to a main system service processor. For simplicity of the description, the collective body of code that enables these various features is referred to herein as WSP utility 145.

According to the illustrative embodiment, when CPU 105 executes WSP utility 145, node 101 initiates a series of functional processes that enable the above functional features as well as additional features/functionality, which are described below within the description of FIGS. 2-5.

Those of ordinary skill in the art will appreciate that the hardware and basic configuration depicted in FIG. 1 may vary. For example, other devices/components may be used in addition to or in place of the hardware depicted. The depicted example is not meant to imply architectural limitations with respect to the present invention.

With reference now to FIG. 2, there is depicted a block diagram representation of an enterprise system. Enterprise network 200 comprises one or more nodes similar to node 101 (FIG. 1), node 0 201, node 1 203, node 2 205, and node N 207 (where ‘N’ is an integer variable). Node 0 201, node 1 203, node 2 205, and node N 207 each comprise service processors 202A and 202B. Service processors 202A and 202B communicate with main system service processor 204 via Ethernet cable 220.

In one embodiment, service processors 202A and 202B communicate with main system service processor 204 to complete tasks within enterprise network 200. Service processor 202B is a redundant (back up) service processor to 202A. The service processors (202A and 202B) comprise built in network interface devices (such as NID 150 of FIG. 1) which allow communication with main system service processor 204. Service processors 202A and 202B communicate with main system service processor 204 via Ethernet cable 220. Ethernet cable 220 enables secure transfer of security settings between main system service processor 204 and service processors 202A and 202B. These service processors are associated with a node and, as such, are referred to hereinafter as node service processors.

In one embodiment, wireless communication on enterprise system 200 is secured by utilizing an encryption. Encryption technologies such as Wi-Fi Protected Access (WPA) with a pre-shared key, LEAP wireless, and wired equivalent policy (WEP) may be incorporated into enterprise network 200 to prevent intrusion and/or interference from one or more other networks or devices.

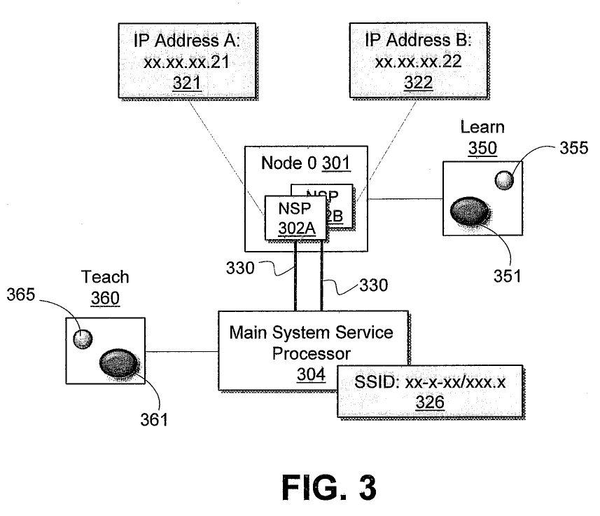

FIG. 3 illustrates service processors within a node physically connected to a main system service processor. Node 301 comprises node service processors 302A and 302B. Node service processors 302A and 302B may be identified via a pre-assigned internet protocol (IP) address, IP address A 321 (node service processor 302B) and IP address B 322 (node service processor 302B). Connected to node 0 301 is learn device 350. Learn device 350 comprises learn button 351 and signal 355. Main system service processor 304 may be identified by service set identifier (SSID) 326. SSID 326 is derived from the serial number and type/model of a machine associated with main system service processor 304. Connected to main system service processor 304 is teach device 360. Teach device 360 comprises teach button 361 and signal 365. Node service processors 302A and 302B are connected to main system service processor 304 via Ethernet cable 330.

In one embodiment, one or more service processors within a node are added to an enterprise network and/or node security settings are modified within an enterprise network. Wireless communication in an enterprise network requires secure communication between service processor devices. A temporary Ethernet connection between node service processor 302A and 302B is utilized to protect the transfer of security settings from node service processor 302A and 302B to main system service processor 304. Node service processor 302A and 302B are identified by IP address A 321 and IP address B 322, respectively. When Ethernet cable 330 is connected between main system service processor 304 and node service processors 302A and 302B, SSID 326 is uploaded from main system service processor 304 to node service processors 302A and 302B. Uploading SSID 326 will allow the WSP utility (145) to establish a unique security identification name for node service processors 302A and 302B.

In one embodiment, teaching and learning devices are utilized to insure complete transfer of security settings between the service processors, prior to utilizing the wireless network. When Ethernet cable 330 is connected between the node service processors (302A and 302B) and main system service processor 304, teach device 360 and learn device 350 transmit and receive security settings of the service processors. Engaging teach button 361 initiates the transfer of security settings (i.e. SSID 326) to node service processor 302A and 302B. Engaging learn button 361 allows node service processor 302A and 302B to receive security settings transferred from main system service processor 304. Teach device 360 may also operate as a learning device, and learn device 350 may also operate as a teaching device. To control whether the system processors are teaching or learning security settings, an order of operation may be established.

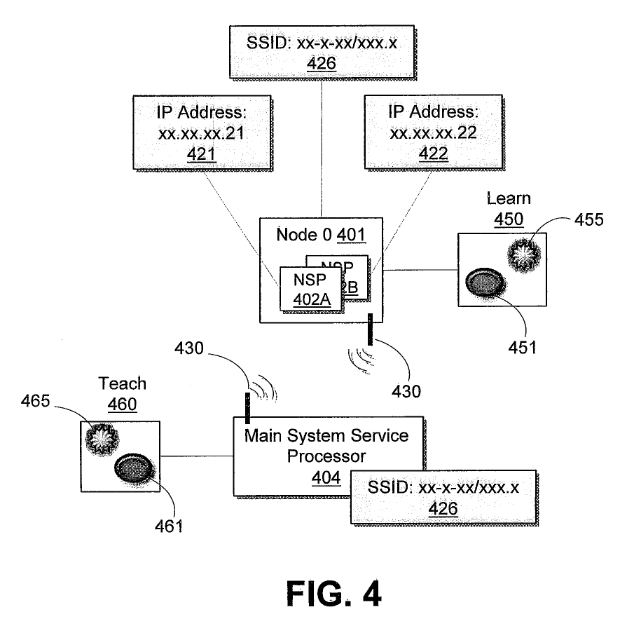

FIG. 4 illustrates service processors within a node, which is wirelessly connected to a main system service processor. Node 0 401 comprises node service processors 402A and 402B. Node service processors 402A and 402B may be identified via a pre-assigned internet protocol (IP) address, IP address A 421 (node service processor 402B) and IP address B 422 (node service processor 402B). Connected to node 0 401 is learning device 450. Learn device 450 comprises learn button 451 and illuminated signal 465. Main system service processor 404 may be identified by service set identifier (SSID) 426. SSID 426 is derived from the serial number and type/model of a machine associated with main system service processor 404. Connected to main system service processor 404 is teach device 460. Teach device 460 comprises teach button 461 and illuminated signal 465. Node service processors 402A and 402B communicated with main system service processor 404 via wireless signal 430.

In one embodiment, teach and learn devices were utilized to transfer security settings. The transferring of security settings comprises uploading a unique identification name, such as SSID 426 from main system service processor 404 to node service processors 402A and 402B, thereby ensure the integrity of wireless communication between one or more node service processors and a main system service processor 404. Engaging teach button 461 and learn button 451 initiates the transfer of security settings (as described above with reference to FIG. 3). When the transfer of security settings is complete, signal 365 becomes illuminated signal 465. When illuminated signal 465 is activated, Ethernet cables 330 may be removed, and wireless signal 430 becomes the method of communication between node service processors (402A and 402B) and main system service processor 404.

In one embodiment, a client may change and/or modify SSID 426 (or any other security settings) of the main system service processor 404. Utilizing a terminal, such as a laptop, dumb terminal, hardware management console (HMC) etc., the client connects the terminal to the main system service processor and performs all necessary changes. When SSID 426 (and additional security settings) have been modified, changes may be performed to the service processors within the node, a single service processor at a time.

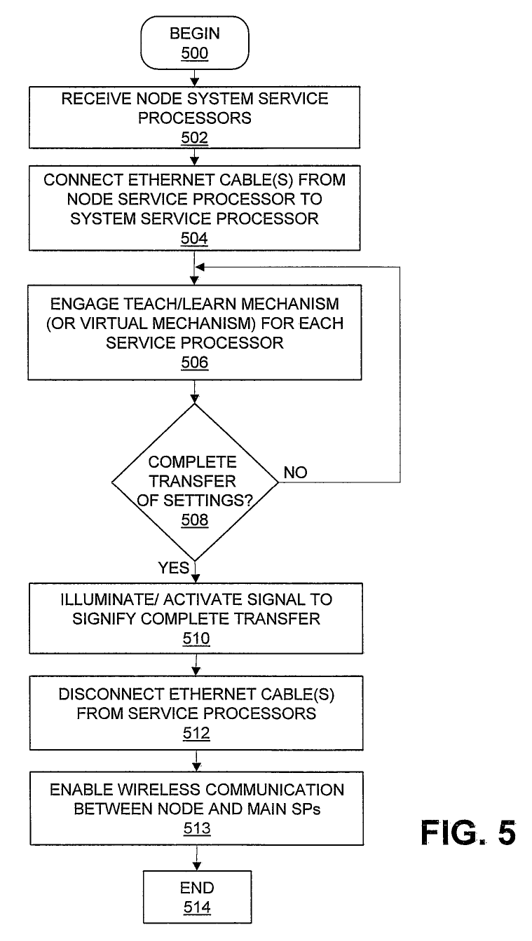

FIG. 5 is a flow chart illustrating the method by which the above processes of the illustrative embodiments are completed. Specifically, FIG. 5 depicts the method in which a node service processor is integrated into a wireless enterprise system. Although the methods illustrated in FIG. 5 may be described with reference to components shown in FIGS. 1-4, it should be understood that this is merely for convenience and alternative components and/or configurations thereof can be employed when implementing the various methods. Key portions of the methods may be completed by WSP utility 145 executing within node 101 (FIG. 1) and controlling specific operations on node 101, and the methods are thus described from the perspective of either/both WPS utility 145 and node 101.

The process of FIG. 5 begins at initiator block 500 and proceeds to block 502, at which a node is added to the wireless enterprise network. At block 504 an Ethernet cable is connected between node service processors 302 (FIG. 3) and main system service processor 304 (FIG. 3). Teach button 361 and learn button 351 are engaged to initiate the transfer of security settings from main system service processor 304 to node service processors 302, at block 506. A decision is made at block 508, whether the transfer of security settings has been completed. If the transfer is complete, the process continues to block 510. If the transfer is not complete, the process returns to block 506. When WSP utility 145 has detected that the transfer of security settings is complete, the transfer is signified to the operator as an illuminated signal, at block 510. At block 512, the Ethernet cables are disconnected from node service processors 302 and main system service processor 404. Wireless communication is then enabled between the main system service processor 404 and the node service processor 302, as shown at block 513. The process ends at block 514.

In the flow charts above, one or more of the methods are embodied as a computer program product in a computer readable medium or containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture (or computer program product) in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a computer program product in a variety of forms, and that an illustrative embodiment of the present invention applies equally regardless of the particular type of media used to actually carry out the distribution. By way of example, a non exclusive list of types of media, includes recordable type (tangible) media such as floppy disks, thumb drives, hard disk drives, CD ROMs, DVDs, and transmission type media such as digital and analogue communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A method comprising:
associating a wireless transceiver with both a main system service processor and each of one or more node service processors, which wireless transceiver enables wireless transmission and receipt of information via a resulting wireless network between the main system service processor and the one or more node service processors, wherein said wireless transmission and receipt of information occurs only when the one or more node service processors and the resulting wireless network are properly configured to receive and transmit information via a wireless medium;
associating a learning device with the one or more node service processors;
associating a corresponding teaching device with the main system service processor;
connecting the one or more node service processors to a main system service processor via a wired Ethernet cable connection;
in response to the main system service processor being connected to the one or more node service processors via the wired Ethernet cable connection:
engaging a trigger on the teaching device to initialize a data transfer of configuration information to the learning device, in order to configure the wireless network; and
engaging a trigger on the learning device to enable receipt of the configuration information from the teaching device;
wherein the engaging of the trigger causes the main service processor to perform the steps of:
assigning an unique identification (ID) to the connected one or more node service processors; and
initiating a transfer of the unique ID and other security parameters and information required to set up and support wireless communication exchange with the one or more node service processors;
monitoring the indicator on the teaching device and the learning device to determined when the transfer of the unique ID and the other security parameters and information are completed; and
when the transfer of the unique ID and the other security parameters and information are completed:
removing the Ethernet cable connection; and
initiating wireless communication between the main system service processor and the one or more node service processors.

2. The method of claim 2, wherein the teaching device and the learning device each has an indicator button that illuminates when the trigger of the respective device is engaged and de-illuminates after the wireless configuration is completed.

3. A system comprising:
a main system service processor having (a) a first wireless transceiver, (b) and Ethernet port, and (c) a processing logic for performing a series of functions when triggered by a pre-specific user input that enables the main service processor to transmit and receive information via the first wireless transceiver;
one or more node service processors also having (a) a second wireless transceiver, (b) an Ethernet port, and (c) processing logic for receiving information related to a establishing a wireless network with the main system service processor utilizing the second wireless transceiver to wirelessly transmit and receive service processor information to and from the main system service processor;
a teaching device associated with the main system service processor and also having an indicator and a selectable trigger for enabling the teaching device to initiate a transmission of information;
a learning device associated with the one or more node service processors having an indicator and a selectable trigger for enabling the learning device to receive information from the teaching device;
user means for performing a series of functions including:
associating the wireless transceiver with both the main system service processor and each of one or more node service processors, which wireless transceiver enables wireless transmission and receipt of information via a resulting wireless network between the main system service processor and the one or more node service processors, wherein said wireless transmission and receipt of information occurs only when the one or more node service processors and the resulting wireless network are properly configured to receive and transmit information via a wireless medium;
connecting the one or more node service processors to a main system service processor via a wired Ethernet cable connection having connective ends respectively coupled to an Ethernet port of the main system service processor and one of the node service processors;
in response to the main system service processor being connected to the one or more node service processors via the wired Ethernet cable connection:
engaging a trigger on the teaching device to initialize a data transfer of configuration information to the learning device, in order to configure the wireless network; and
engaging a trigger on the learning device to enable receipt of the configuration information from the teaching device;
wherein the engaging of the trigger causes the main service processor to perform the steps of:
assigning an unique identification (ID) to the connected one or more node service processors; and
initiating a transfer of the unique ID and other security parameters and information required to set up and support wireless communication exchange with the one or more node service processors;
monitoring the indicator on the teaching device and the learning device to determined when the transfer of the unique ID and the other security parameters and information are completed; and
when the transfer of the unique ID and the other security parameters and information are completed:
removing the Ethernet cable connection; and
initiating wireless communication between the main system service processor and the one or more node service processors.

4. The method of claim 3, wherein the teaching device and the learning device each has an indicator button that illuminates when the trigger of the respective device is engaged and de-illuminates after the wireless configuration is completed.
